(19) United States
(12) Patent Application Publication
(10) Pub. No.: US 2025/0329998 A1
(43) Pub. Date: Oct. 23, 2025

(54) Isolation Structure For Electrical Device

(71) Applicant: Zhuhai Shengchang Electronics Co., Ltd., Zhuhai City (CN)

(72) Inventors: Jialong HU, Zhuhai City (CN); Dehua ZHENG, Zhuhai City (CN)

(73) Assignee: Zhuhai Shengchang Electronics Co., Ltd., Zhuhai City (CN)

(21) Appl. No.: 18/733,938

(22) Filed: Jun. 5, 2024

(30) Foreign Application Priority Data
Apr. 18, 2024 (CN) 2024208139276
May 9, 2024 (CN) 2024209996500

(51) Int. Cl. H02B 11/04; H02B 1/20; H02B 1/46

(52) U.S. Cl. CPC H02B 11/04; H02B 1/202; H02B 1/46

(57) ABSTRACT

The present disclosure provides an isolation structure for an electrical device, comprising a clamping piece, an isolation piece, a buckling assembly, one end of the clamping piece is provided with a limiting cavity, and the limiting cavity is a groove or a through hole; one end of the isolation piece is detachably connected to the clamping piece, so that the isolation piece separates one side of the clamping piece into different intervals; and the buckling assembly is fixed at one end of the isolation piece, and the buckling assembly includes a convex bar and a hook arranged at intervals; observed along an arrangement direction of different intervals, the limiting cavity fixes the convex bar through a up and down direction limit or a up and down direction limit in combination with a left and right direction limit. The isolation structure of the present disclosure is conducive to improving connection stability.

### TECHNICAL FIELD

The present disclosure herein relates to the technical field of electrical equipment, specifically to an isolation structure for an electrical device and an electrical device with an isolation function.

### BACKGROUND

At present, due to the structural limitations of electrical devices (such as dimmers), there may be cross stacking of wires connecting different terminal blocks within different wiring pieces, leading to wire skin damage and short circuits. Therefore, the safety of existing electrical devices is relatively low.

### SUMMARY

In order to overcome the shortcomings of the prior art, the purpose of the present disclosure is to provide an isolation structure that is conducive to improving connection stability.

In addition, the present disclosure also provides an electrical device with an isolation function, which is conducive to improving the safety in the use of the electrical device.

To solve the above problems, the technical solution adopted by the present disclosure is as follows:
an isolation structure, comprising:
a clamping piece, wherein one end of the clamping piece is provided with a limiting cavity, and the limiting cavity is a groove or a through hole;
an isolation piece, wherein one end of the isolation piece is detachably connected to the clamping piece, so that the isolation piece separates one side of the clamping piece into different intervals; and
a buckling assembly, wherein the buckling assembly is fixed at one end of the isolation piece, and the buckling assembly includes a convex bar and a hook arranged at intervals; observed along an arrangement direction of different intervals, the limiting cavity fixes the convex bar through a up and down direction limit or a up and down direction limit in combination with a left and right direction limit; the hook includes a connected elastic arm and a hook portion, and the elastic arm is fixed to the isolation piece; the hook portion is abutted against an edge of the limiting cavity, so that the convex bar cannot detach from the limiting cavity from at least one side of the left and right direction or from a front and rear direction.

In some possible embodiments, the limiting cavity is the groove, and the limiting cavity penetrates through the clamping piece in the left and right direction, and the limiting cavity includes:
a first cavity portion; and
a second cavity portion, wherein the second cavity portion is located below and connected to the first cavity portion, and an aperture of the second cavity portion is larger than that of the first cavity portion;
the convex bar is fixed inside the second cavity portion, the elastic arm is fixed on a left end face or a right end face of the isolation piece, the elastic arm is arranged at intervals from a side wall of the first cavity portion away from the hook portion, the hook portion is protruded on a front end face or a rear end face of the elastic arm, and the hook portion is abutted against an edge of the first cavity portion; and
the isolation structure further includes:
a limiting piece, wherein the limiting piece is adjacent to the convex bar and the isolation piece, the limiting piece is arranged at one end of the isolation piece away from the hook, and the limiting piece is abutted against an edge of the limiting cavity away from the hook.

In some possible embodiments, the clamping piece includes:
a body, wherein the body forms a bottom wall of the second cavity portion; and
a connecting component, wherein the connecting component is arranged at one end of the body, the connecting component includes four first connecting pieces, each of the two first connecting pieces is arranged at intervals along the front and rear direction and bent in an opposite direction, each of the two first connecting pieces bent in the opposite direction forms one of the limiting cavities with the body, and the two limiting cavities are arranged at intervals along the left and right direction; the elastic arm is arranged at intervals with the first connecting piece, the hook portion is abutted against another one of the first connecting pieces that is bent in the opposite direction and away from an end face of the limiting piece, and the limiting piece is abutted against an edge of another one of the limiting cavities away from the hook.

In some possible embodiments, the clamping piece includes:
a body, wherein the body forms a bottom wall of the second cavity portion; and
a connecting component, wherein the connecting component is arranged at one end of the body, the connecting component includes two first connecting pieces arranged at intervals along the front and rear direction, the first connecting pieces extend to a left and right end of the clamping piece, and the two first connecting pieces are bent in the opposite direction to form the limiting cavity with the body; and
the elastic arm is arranged at intervals with one of the first connecting pieces, the hook portion is abutted against another one of the first connecting pieces, and the limiting piece is abutted against an end face of the same limiting cavity away from the hook.

In some possible embodiments, the clamping piece includes the body, and one end face of the body is recessed to form the limiting cavity.

In some possible embodiments, the clamping piece includes:
a body; and
a connecting component, wherein the connecting component is arranged at one end of the body, the connecting component includes two first connecting pieces and a second connecting piece, the two first connecting pieces are arranged at intervals along the front and rear direction, and the second connecting piece is connected to one end of the two first connecting pieces, the two first connecting pieces are bent in the opposite direction, so that the first connecting piece, the body, and the second connecting piece jointly form the limiting cavity with a groove structure, and the limiting cavity includes:
a first cavity portion; and
a second cavity portion, wherein the second cavity portion is connected to the first cavity portion, an aperture of the second cavity portion is larger than that of the first cavity portion, and the body forms a bottom wall of the second cavity portion; and
the convex bar is fixed inside the second cavity portion, one end of the isolation piece relative to the clamping piece is provided with a containment groove, the convex bar is arranged at an edge of the containment groove, the elastic arm is arranged inside the containment groove, the elastic arm is protruded on a side wall of the containment groove adjacent to the convex bar, a bottom wall of the hook portion away from the containment groove is protruded on the elastic arm, and the hook portion is abutted against an end face of the second connecting piece away from the limiting cavity.

In some possible embodiments, it also includes:
a limiting piece, wherein the limiting piece is adjacent to the convex bar and the isolation piece, the limiting piece is arranged at one end of the isolation piece away from the hook, and the limiting piece is abutted against an edge of the limiting cavity away from the second connecting piece.

In some possible embodiments, the clamping piece includes:
a body; and
a connecting component, wherein the connecting component is arranged at one end of the body, the connecting component includes two first connecting pieces and a second connecting piece, the two first connecting pieces are arranged at intervals along the left and right direction, and the second connecting piece is connected between the two first connecting pieces, so that the first connecting piece, the second connecting piece, and the body form the limiting cavity with a through hole structure; and
the buckling assembly is protruded on a front end face or a rear end face of the isolation piece, the elastic arm is arranged on one side of one of the first connecting pieces away from another one of the first connecting pieces, and the hook portion is abutted against an edge of the limiting cavity away from the isolation piece.

In some possible embodiments, the front end face or rear end face of the isolation piece are recessed to form a plurality of breaking grooves, and a plurality of breaking grooves are arranged at intervals along a direction away from the buckling assembly.

The present application also provides an electrical device with an isolation function, comprising the isolation structure, wherein the clamping piece is provided with at least two terminal blocks, and at least two terminal blocks are arranged in different intervals;
the electrical device further includes:
a mounting fixing plate, wherein the mounting fixing plate and the clamping piece together form a mounting cavity;
a circuit component wherein the circuit component is installed in the mounting cavity, and the terminal block is electrically connected to the circuit component; and
a wiring piece, wherein the wiring piece is detachably connected to the mounting fixing plate to jointly form a containment cavity, wherein the isolation structure is arranged in the containment cavity, so that the isolation piece isolates the containment cavity into different intervals; the wiring piece is provided with at least two ports, one of the ports is arranged relative to one of the intervals, and another one of the ports is arranged relative to another one of the intervals, and the ports are either opening holes or knockout holes.

Compared to the prior art, the present disclosure has the following beneficial effects: in the present application, the isolation piece is detachably connected to the clamping piece through the buckling assembly, so that one side area of the clamping piece is separated into different intervals, so that when the isolation structure is applied to the electrical device, the isolation structure is able to isolate the containment cavity into different intervals, so that at least two terminal blocks can be laid in different intervals, which in turn will not result in cross-stacking of the electrical wires when the different terminal blocks are connected to different wires, and therefore, the electrical device of the present disclosure has high safety in use. In addition, the isolation structure of the present disclosure adopts the convex bar and the hook to cooperate with the limiting cavity to realize the detachable connection of the clamping piece and the isolation piece, which can be fixed by multi-directional contact, and thus is conducive to improving the connection stability of the isolation structure.

Below, a further detailed explanation of the present disclosure will be provided in conjunction with the accompanying drawings and specific implementation methods.

### BRIEF DESCRIPTION OF THE DRAWINGS

FIG. 1 is a partial explosion diagram of an electrical device provided in an embodiment of the present disclosure;

FIG. 2 is a schematic diagram of a local structure of an electrical device shown in FIG. 1;

FIG. 3 is an enlarged view of Part A shown in FIG. 2;

FIG. 4 is another perspective view of a local structure shown in FIG. 2;

FIG. 5 is an enlarged view of Part B shown in FIG. 4;

FIG. 6 is a cross-sectional view of FIG. 4 along V-V;

FIG. 7 is a schematic diagram of a structure of an isolation piece and a buckling assembly shown in FIG. 1;

FIG. 8 is a schematic diagram of a local structure of an electrical device provided in another embodiment;

FIG. 9 is a schematic diagram of a local structure after removing an isolation piece in FIG. 8;

FIG. 10 is a schematic diagram of a local structure of an electrical device provided in another embodiment;

FIG. 11 is a schematic diagram of a local structure of an electrical device provided in another embodiment;

FIG. 12 is a partial explosion diagram of FIG. 11;

FIG. 13 is a schematic diagram of a local structure of an electrical device provided in another embodiment;

FIG. 14 is a partial explosion diagram of FIG. 13; and

FIG. 15 is a schematic diagram of a local structure of an electrical device provided in another embodiment.

### ATTACHED FIG. LABEL DESCRIPTION

100—electrical device; 10—clamping piece; 11—body; 12, 12′, 12″, 12′—connecting component; 110—terminal block; 101, 101′, 101″, 101′—limiting cavity; 1011—first cavity portion; 1012—second cavity portion; 102—mounting groove; 20—isolation piece; 201—breaking groove; 202—gap; 203—groove; 204—containment groove; 2020—arc-shaped side wall; 30—buckling assembly; 31, 31′—convex bar; 32, 32′, 32″—hook; 321, 321′, 321″—elastic arm; 322, 322′, 322″—hook portion; 40—limiting piece; 50—mounting fixing plate; 70—circuit component; 80—wiring piece; 801—opening hole; 802—sealing plug; 803—port; 90—adjusting switch.

### DETAILED DESCRIPTION OF THE EMBODIMENTS

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in the present disclosure, all other embodiments obtained by those ordinary skilled in the art without creative labor are within the scope of protection of the present disclosure.

The terms “first”, “second”, etc., in the specification and claims of the present disclosure and the accompanying drawings described above are used to distinguish between different objects and are not intended to describe a particular order. In addition, the terms “including” and “having” and any variations thereof are intended to cover non-exclusive inclusions. It should be noted that when an element is referred to as “fixed to” another element, it can be directly attached to the other element or there can be a centered element. When an element is referred to as “connected to” another element, it can be directly connected to another element or there can be a centered element. When an element is referred to as “arranged on” another element, it can be arranged on another element or there can be a centered element.

### Embodiment 1

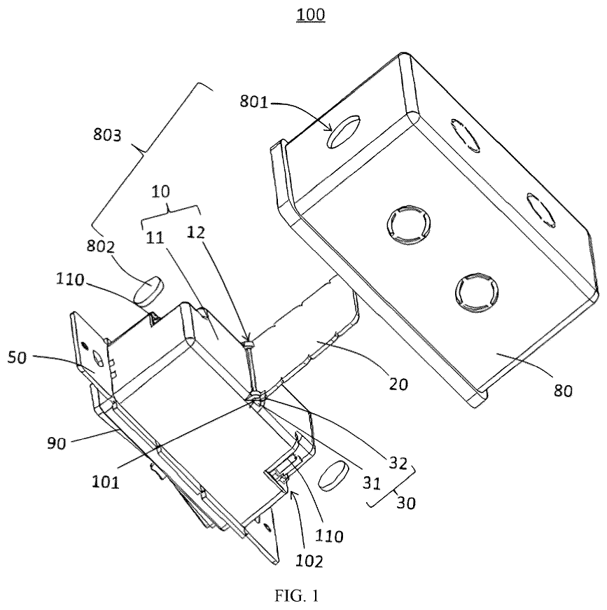

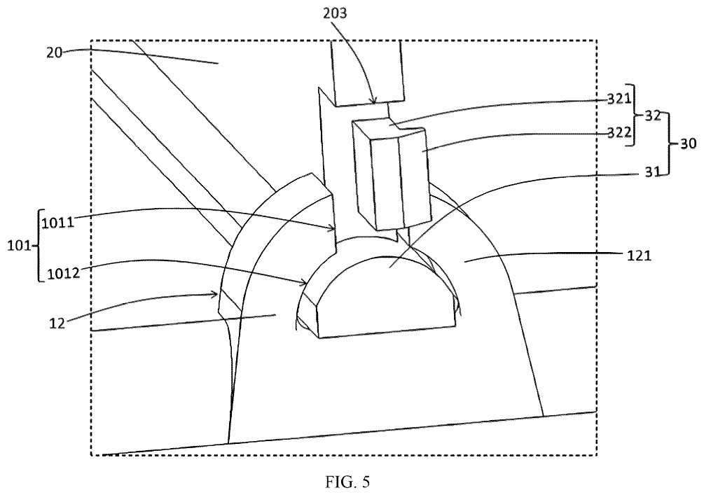

Referring to FIG. 1 to FIG. 7, an embodiment of the present disclosure provides an electrical device with an isolation function, hereinafter referred to as the electrical device 100. For example, the electrical device 100 may include a dimmer or an electronic doorbell. The electrical device 100 includes an isolation structure, a mounting fixing plate 50, a circuit component 70 (refer to FIG. 6), and a wiring piece 80. For example, the circuit component 70 may include a voltage conversion module or a control module, and the structural composition of the circuit component 70 may change according to the specific use of the electrical device 100.

In some embodiments, the isolation structure includes a clamping piece 10, an isolation piece 20, and a buckling assembly 30. One end of the clamping piece 10 is provided with a limiting cavity 101, and the limiting cavity 101 is a groove or a through hole. One end of the isolation piece 20 is detachably connected to the clamping piece 10, so that the isolation piece 20 separates one side of the clamping piece 10 into different intervals. The buckling assembly 30 is fixed at one end of the isolation piece 20, and the buckling assembly 30 includes a convex bar 31 and a hook 32 arranged at intervals; observed along an arrangement direction of different intervals, the limiting cavity 101 fixes the convex bar 31 through a up and down direction limit or a up and down direction limit in combination with a left and right direction limit. The hook 32 includes a connected elastic arm 321 and a hook portion 322, and the elastic arm 321 is fixed to the isolation piece 20; the hook portion 322 is abutted against an edge of the limiting cavity 101, so that the convex bar 31 cannot detach from the limiting cavity 101 from at least one side of the left and right direction or from a front and rear direction. For example, at least one of the clamping piece 10, the isolation piece 20, and the buckling assembly 30 can be a plastic piece; for example, the elastic arm 321 can be a square structure; and for example, the hook 32 can be integrally formed and provided.

The clamping piece 10 is provided with at least two terminal blocks 110 (the two terminal blocks 110 are shown in the FIG.), and at least two terminal blocks 110 are arranged in different intervals. The mounting fixing plate 50 and the clamping piece 10 to jointly form a mounting cavity 103 (refer to FIG. 6), the circuit component 70 is installed in the mounting cavity 103, and the terminal block 110 is electrically connected to the circuit component 70. The wiring piece 80 is detachably connected to the mounting fixing plate 50 to jointly form a containment cavity (not shown in the FIG.), wherein the isolation structure is arranged in the containment cavity, so that the isolation piece 20 isolates the containment cavity into different intervals.

For example, an end of the isolation piece 20 away from the clamping piece 10 can be abutted against the wiring piece 80, or it can be arranged at intervals with the wiring piece 80. For example, the wiring piece 80 can be connected to the mounting fixing plate 50 by fixing it with a screw.

The wiring piece 80 is provided with at least two ports 803 (the two ports 803 are shown in the FIG.), one of the ports 803 is arranged relative to one of the intervals, and another one of the ports 803 is arranged relative to another one of the intervals, and the ports 803 are either opening holes or knockout holes. In the present disclosure, the port 803 is a knockout hole formed by a sealing plug 802 micro connection and covering an opening hole 801. Specifically, knocking out the sealing plug 802 can expose the opening hole 801. In specific applications, different wires can pass through different ports 803 to connect different terminal blocks 110, thereby achieving electrical connections between the electrical device and other functional elements (such as light sources).

For example, the mounting fixing plate 50 can be a plate structure, and both the wiring piece 80 and the clamping piece 10 can be a box structure, so that the mounting fixing plate 50 closes the wiring piece 80 and the clamping piece 10 to form the containment cavity and the mounting cavity 103, respectively.

In the present application, the isolation piece 20 is detachably connected to the clamping piece 10 through the buckling assembly 30, so that one side area of the clamping piece 10 is separated into different intervals, so that when the isolation structure is applied to the electrical device 100, the isolation structure can isolate the containment cavity into different intervals, so that at least two terminal blocks 110 can be laid in different intervals, which in turn will not result in cross-stacking of the electrical wires when the different terminal blocks 110 are connected to different wires, and therefore, the electrical device 100 of the present disclosure has high safety in use. In addition, the isolation structure of the present disclosure adopts the convex bar 31 and the hook 32 to cooperate with the limiting cavity 101 to realize the detachable connection of the clamping piece 10 and the isolation piece 20, which can be fixed by multi-directional contact, and thus is conducive to improving the connection stability of the isolation structure.

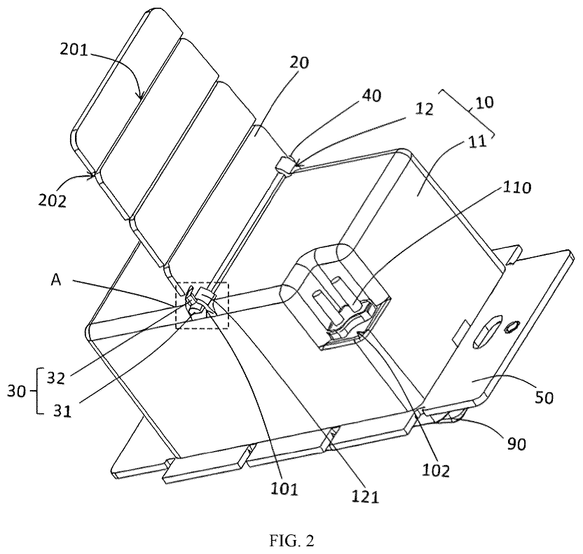

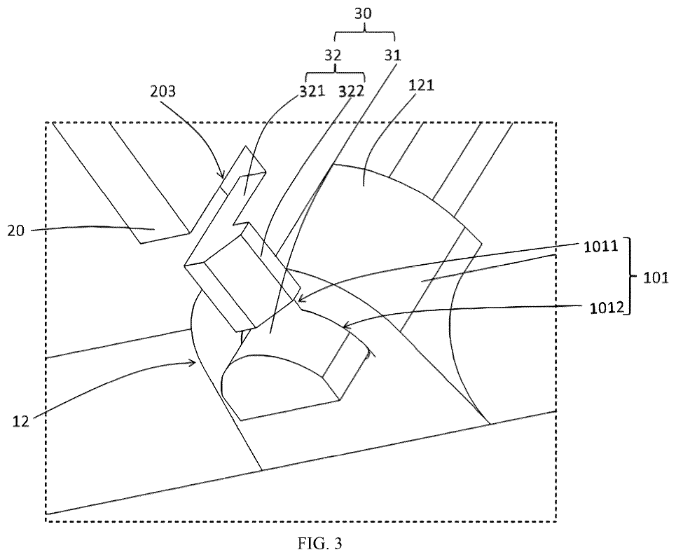

In some embodiments, the limiting cavity 101 is the groove, the limiting cavity 101 penetrates through the clamping piece 10 in the left and right direction, referring to FIG. 2 and FIG. 3, the limiting cavity 101 includes a first cavity portion 1011 and a second cavity portion 1012, the second cavity portion 1012 is located below and connected to the first cavity portion 1011, and an aperture of the second cavity portion 1012 is larger than that of the first cavity portion 1011. The convex bar 31 is fixed inside the second cavity portion 1012, due to the aperture of the first cavity portion 1011 is smaller than that of the second cavity portion 1012, the second cavity portion 1012 can at least limit the convex bar 31 in the up and down directions to prevent the buckling assembly 30 from detaching from the limiting cavity 101. The elastic arm 321 is fixed on a left end face or a right end face of the isolation piece 20, the elastic arm 321 is arranged at intervals from a side wall of the first cavity portion 1011 away from the hook portion 322, the hook portion 322 is protruded on a front end face or a rear end face of the elastic arm 321, and the hook portion 322 is abutted against an edge of the first cavity portion 1011; the elastic arm 321 is arranged intervals with the side wall, which facilitates the deformation of the elastic arm 321, thereby improving the disassembly convenience of the buckling assembly 30 by separating the hook portion 322 from the edge of the first cavity portion 1011. The isolation structure further includes a limiting piece 40, wherein the limiting piece 40 is adjacent to the convex bar 31 and the isolation piece 20, the limiting piece 40 is arranged at one end of the isolation piece 20 away from the hook 32; that is, one of the limiting piece 40 and the hook 32 is arranged at a left end of the isolation piece 20 and another one is arranged at a right end of the isolation piece 20, the limiting piece 40 is abutted against an edge of the limiting cavity 101 away from the hook 32, so that the limiting piece 40 and the hook 32 cooperate to further limit the left and right directions of the buckling assembly 30, thereby further improving the connection stability between the isolation piece 20 and the clamping piece 10.

In some embodiments, referring to FIG. 1 to FIG. 7, the clamping piece 10 includes a body 11 and a connecting component 12, the body 11 forms a bottom wall of the second cavity portion 1012, the connecting component 12 is arranged at one end of the body 11, the connecting component 12 includes four first connecting pieces 121, each of the two first connecting pieces 121 is arranged at intervals along the front and rear direction and bent in an opposite direction to form the limiting cavity 101 with the first cavity portion 1011 and the second cavity portion 1012. For example, the first connecting piece 121 can be bent to form an arc-shaped structure, so that the second cavity portion 1012 has an arc-shaped side wall. Each of the two first connecting pieces 121 bent in the opposite direction forms one of the limiting cavities 101 with the body 11, and the two limiting cavities 101 are arranged at intervals along the left and right direction; the elastic arm 321 is arranged at intervals with the first connecting piece 121, the hook portion 322 is abutted against another one of the first connecting pieces 121 that is bent in the opposite direction and away from an end face of the limiting piece 40, and the limiting piece 40 is abutted against an edge of another one of the limiting cavities 101 away from the hook 32. The use of a plurality of first connecting pieces 121 in conjunction with the body 11 to form the limiting cavity 101 can reduce the resistance of the isolation structure during disassembly and assembly, thereby improving the convenience of disassembly and assembly of the isolation structure.

In some embodiments, referring to FIG. 3, an end face of the isolation piece 20 away from the limiting piece 40 is recessed to form a groove 203, the hook 32 is arranged inside the groove 203, and the convex bar 31 is disposed within the groove 203, that is, the convex bar 31 may form one side wall of the groove 203. The hook 32 is arranged inside the groove 203 to improve the integration of the isolation structure.

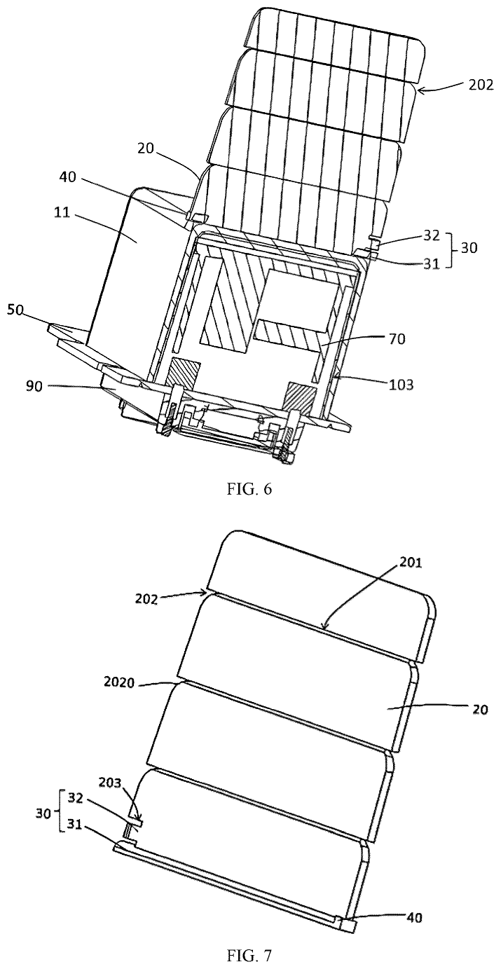

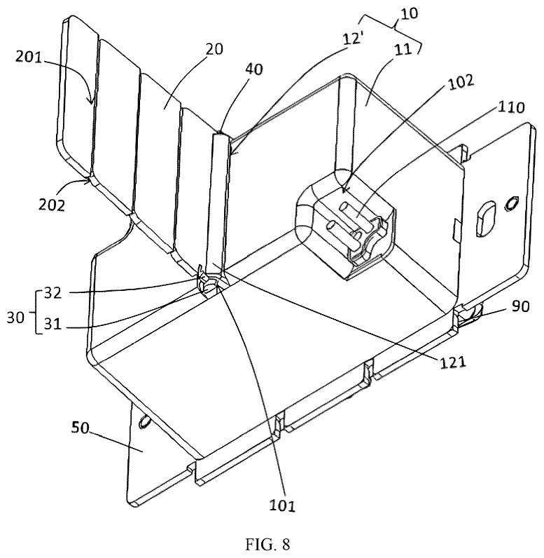

In some embodiments, referring to FIG. 2 and FIG. 7, a front end face or a rear end face of the isolation piece 20 are recessed to form a plurality of breaking grooves 201, and a plurality of breaking grooves 201 are arranged at intervals along a direction away from the buckling assembly 30. In specific applications, a portion of the isolation piece 20 can be broken off according to a trajectory of the breaking groove 201, so as to adjust a length of the isolation piece 20 and enable the isolation piece 20 to adapt to different sizes of the wiring piece 80 (referring to FIG. 1). Therefore, the breaking groove 201 is beneficial for improving a size adaptability of the isolation piece 20.

In some embodiments, referring to FIG. 6 and FIG. 7, at least one of a left end face and right end face of the isolation piece 20 is provided with a plurality of gaps 202 arranged at intervals, each of the gaps 202 is connected to one of the breaking grooves 201, and the combination of the gaps 202 and the breaking grooves 201 is conducive to reducing a breaking strength of the breaking grooves 201, thereby improving the convenience of adjusting a size of the isolation piece 20.

In some embodiments, each gap 202 has an arc-shaped side wall 2020 arranged closer to the clamping piece 10, and the arc-shaped side wall 2020 is bent relative to the clamping piece 10. A shape of the gap 202 is conducive to further improving the convenience of adjusting the size of the isolation piece 20.

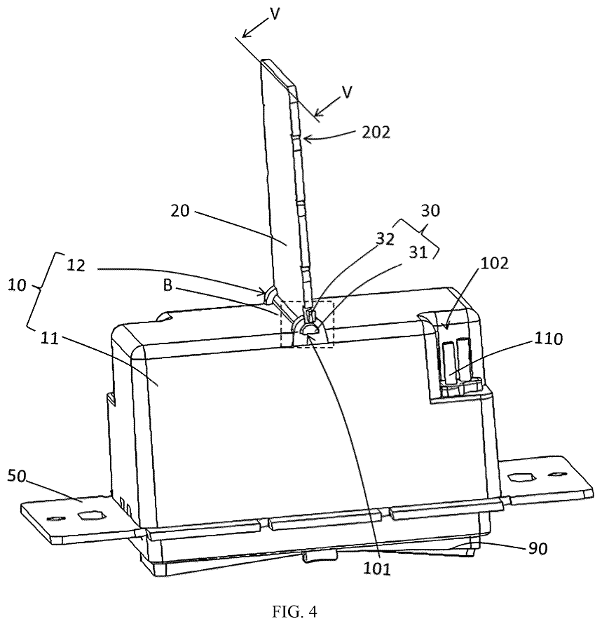

In some embodiments, referring to FIG. 2 and FIG. 4, an end face of the clamping piece 10 relative to the isolation piece 20 are recessed to form at least two mounting grooves 102, and each of the terminal blocks 110 is arranged inside one of the mounting grooves 102. For example, the number of mounting grooves 102 can be the same as the number of the terminal block 110, the provision of mounting grooves 102 is conducive to improving the isolation of the terminal block 110 and further improving the safety of use of the electrical device 100.

In some embodiments, the mounting fixing plate 50 may be installed with an adjusting switch 90, and the adjusting switch 90 can be electrically connected to the circuit component 70.

### Embodiment 2

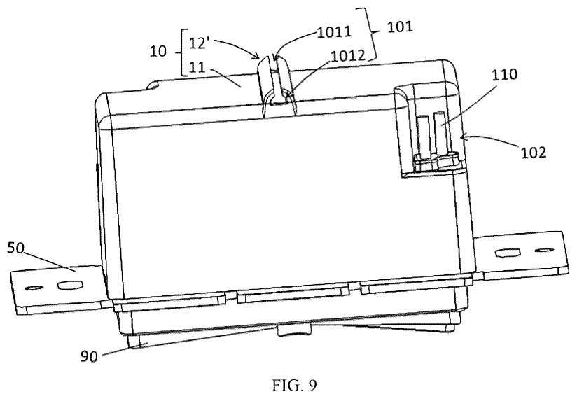

Referring to FIG. 8 and FIG. 9, the isolation structure provided in an embodiment of the present disclosure differs from the isolation structure provided in Embodiment 1 in that the connecting component 12′ of the clamping piece 10 includes two first connecting pieces 121 arranged at intervals along the front and rear direction, the first connecting pieces 121 extend to a left and right end of the clamping piece 10, and the two first connecting pieces 121 are bent in the opposite direction to form the limiting cavity 101 with the body 11, that is, each of the connecting components 12′ forms one of the limiting cavities 101, and the limiting piece 40 is abutted against an end face of the same limiting cavity 101 away from the hook 32. A structure of the connecting component 12′ is more conducive to increasing the number of limit points compared to Embodiment 1, which in turn is more conducive to the isolation structure having greater connection stability.

### Embodiment 3

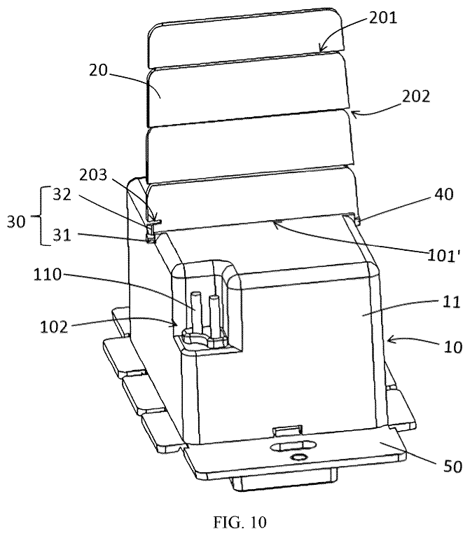

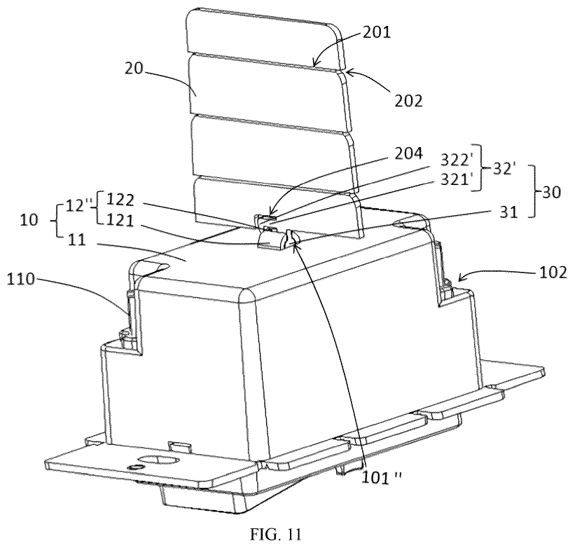

Referring to FIG. 10, the isolation structure provided in an embodiment of the present disclosure differs from the isolation structure provided in Embodiment 1 in that the clamping piece 10 includes the body 11, and one end face of the body 11 is recessed to form the limiting cavity 101′. At this point, it is beneficial to simplify the structure of the isolation structure.

### Embodiment 4

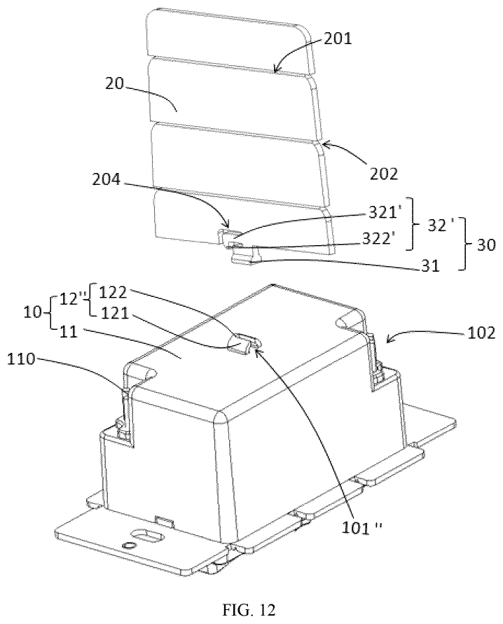

Referring to FIG. 11 and FIG. 12, the isolation structure provided in an embodiment of the present disclosure differs from the isolation structure provided in Embodiment 1 in that the connecting component 12″ includes two first connecting pieces 121 and a second connecting piece 122, the second connecting piece 122 is connected to one end of the two first connecting pieces 121, the first connecting piece 121, the body 11, and the second connecting piece 122 jointly form the limiting cavity 101″ with a groove structure. One end of the isolation piece 20 relative to the clamping piece 10 is provided with a containment groove 204, the convex bar 31 is arranged at an edge of the containment groove 204, the elastic arm 321′ is arranged inside the containment groove 204, the elastic arm 321′ is protruded on a side wall of the containment groove 204 adjacent to the convex bar 31, a bottom wall of the hook portion 322′ away from the containment groove 204 is protruded on the elastic arm 321′, and the hook portion 322′ is abutted against an end face of the second connecting piece 122 away from the limiting cavity 101″.

### Embodiment 5

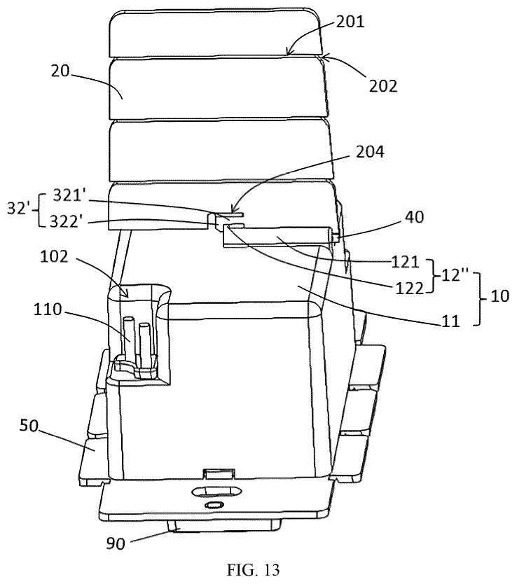

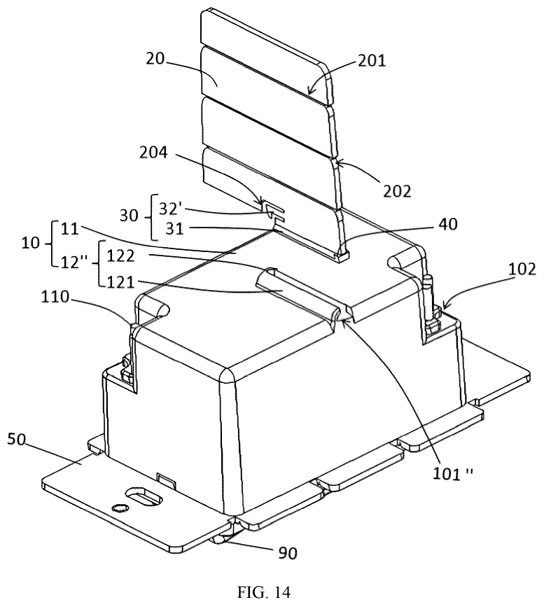

Referring to FIG. 13 and FIG. 14, the isolation structure provided in an embodiment of the present disclosure differs from the isolation structure provided in Embodiment 4 in that the isolation structure further includes the limiting piece 40, the limiting piece 40 is adjacent to the convex bar 31 and the isolation piece 20, the limiting piece 40 is arranged at one end of the convex bar 31 away from the hook 32′, and the limiting piece 40 is abutted against an edge of the limiting cavity 101″ away from the second connecting piece 122.

### Embodiment 6

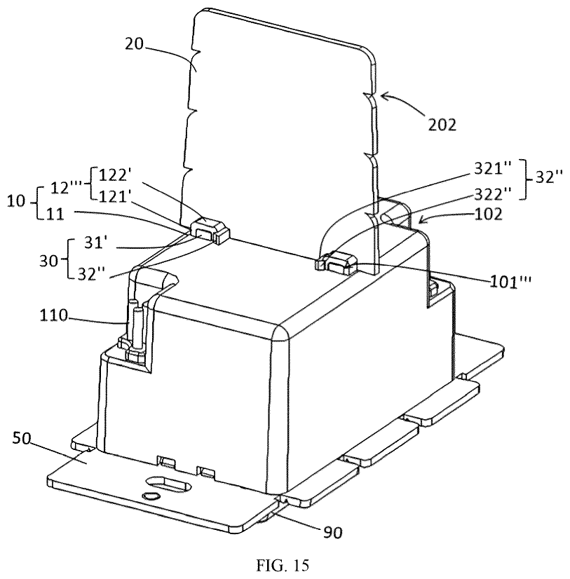

Referring to FIG. 15, the isolation structure provided in an embodiment of the present disclosure differs from the isolation structure provided in Embodiment 1 in that the connecting component 12′″ includes two first connecting pieces 121′ and a second connecting piece 122′, the two first connecting pieces 121′ are arranged at intervals along the left and right direction, and the second connecting piece 122′ is connected between the two first connecting pieces 121′, so that the first connecting piece 121′, the second connecting piece 122′, and the body 11 form the limiting cavity 101′″ with a through hole structure. The buckling assembly 30 is protruded on a front end face or a rear end face of the isolation piece 20, the elastic arm 321″ is arranged on one side of one of the first connecting pieces 121′ away from another one of the first connecting pieces 121′, so that the elastic arm 321″ is arranged outside the limiting cavity 101″. The hook portion 322″ is abutted against an edge of the limiting cavity 101″ away from the isolation piece 20.

The above embodiments are only preferred embodiments of the present disclosure, which cannot be used to limit the scope of protection of the present disclosure, and any non-substantial changes and substitutions made by those skilled in the art on the basis of the present disclosure belong to the scope of the protection required by the present disclosure.

What is claimed is:

1. An isolation structure for an electrical device, comprising:
a clamping piece, wherein one end of the clamping piece is provided with a limiting cavity, and the limiting cavity is a groove or a through hole;
an isolation piece, wherein one end of the isolation piece is detachably connected to the clamping piece, so that the isolation piece separates one side of the clamping piece into different intervals; and
a buckling assembly, wherein the buckling assembly is fixed at one end of the isolation piece, and the buckling assembly includes a convex bar and a hook arranged at intervals; observed along an arrangement direction of different intervals, the limiting cavity fixes the convex bar through a up and down direction limit or a up and down direction limit in combination with a left and right direction limit; the hook includes a connected elastic arm and a hook portion, and the elastic arm is fixed to the isolation piece; the hook portion is abutted against an edge of the limiting cavity, so that the convex bar cannot detach from the limiting cavity from at least one side of the left and right direction or from a front and rear direction.

2. The isolation structure for the electrical device as claimed in claim 1, wherein the limiting cavity is the groove, and the limiting cavity penetrates through the clamping piece in the left and right direction, and the limiting cavity includes:
a first cavity portion; and
a second cavity portion, wherein the second cavity portion is located below and connected to the first cavity portion, and an aperture of the second cavity portion is larger than that of the first cavity portion;
the convex bar is fixed inside the second cavity portion, the elastic arm is fixed on a left end face or a right end face of the isolation piece, the elastic arm is arranged at intervals from a side wall of the first cavity portion away from the hook portion, the hook portion is protruded on a front end face or a rear end face of the elastic arm, and the hook portion is abutted against an edge of the first cavity portion; and
the isolation structure further includes:
a limiting piece, wherein the limiting piece is adjacent to the convex bar and the isolation piece, the limiting piece is arranged at one end of the isolation piece away from the hook, and the limiting piece is abutted against an edge of the limiting cavity away from the hook.

3. The isolation structure for the electrical device as claimed in claim 2, wherein the clamping piece includes:
a body, wherein the body forms a bottom wall of the second cavity portion; and
a connecting component, wherein the connecting component is arranged at one end of the body, the connecting component includes four first connecting pieces, each of the two first connecting pieces is arranged at intervals along the front and rear direction and bent in an opposite direction, each of the two first connecting pieces bent in the opposite direction forms one of the limiting cavities with the body, and the two limiting cavities are arranged at intervals along the left and right direction; the elastic arm is arranged at intervals with the first connecting piece, the hook portion is abutted against another one of the first connecting pieces that is bent in the opposite direction and away from an end face of the limiting piece, and the limiting piece is abutted against an edge of another one of the limiting cavities away from the hook.

4. The isolation structure for the electrical device as claimed in claim 2, wherein the clamping piece includes:
a body, wherein the body forms a bottom wall of the second cavity portion; and
a connecting component, wherein the connecting component is arranged at one end of the body, the connecting component includes two first connecting pieces arranged at intervals along the front and rear direction, the first connecting pieces extend to a left and right end of the clamping piece, and the two first connecting pieces are bent in the opposite direction to form the limiting cavity with the body; and
the elastic arm is arranged at intervals with one of the first connecting pieces, the hook portion is abutted against another one of the first connecting pieces, and the limiting piece is abutted against an end face of the same limiting cavity away from the hook.

5. The isolation structure for the electrical device as claimed in claim 2, wherein the clamping piece includes the body, and one end face of the body is recessed to form the limiting cavity.

6. The isolation structure for the electrical device as claimed in claim 1, wherein the clamping piece includes:
a body; and
a connecting component, wherein the connecting component is arranged at one end of the body, the connecting component includes two first connecting pieces and a second connecting piece, the two first connecting pieces are arranged at intervals along the front and rear direction, and the second connecting piece is connected to one end of the two first connecting pieces, the two first connecting pieces are bent in the opposite direction, so that the first connecting piece, the body, and the second connecting piece jointly form the limiting cavity with a groove structure, and the limiting cavity includes:
a first cavity portion; and
a second cavity portion, wherein the second cavity portion is connected to the first cavity portion, an aperture of the second cavity portion is larger than that of the first cavity portion, and the body forms a bottom wall of the second cavity portion; and
the convex bar is fixed inside the second cavity portion, one end of the isolation piece relative to the clamping piece is provided with a containment groove, the convex bar is arranged at an edge of the containment groove, the elastic arm is arranged inside the containment groove, the elastic arm is protruded on a side wall of the containment groove adjacent to the convex bar, a bottom wall of the hook portion away from the containment groove is protruded on the elastic arm, and the hook portion is abutted against an end face of the second connecting piece away from the limiting cavity.

7. The isolation structure for the electrical device as claimed in claim 6, further includes:
a limiting piece, wherein the limiting piece is adjacent to the convex bar and the isolation piece, the limiting piece is arranged at one end of the isolation piece away from the hook, and the limiting piece is abutted against an edge of the limiting cavity away from the second connecting piece.

8. The isolation structure for the electrical device as claimed in claim 1, wherein the clamping piece includes:
a body; and
a connecting component, wherein the connecting component is arranged at one end of the body, the connecting component includes two first connecting pieces and a second connecting piece, the two first connecting pieces are arranged at intervals along the left and right direction, and the second connecting piece is connected between the two first connecting pieces, so that the first connecting piece, the second connecting piece, and the body form the limiting cavity with a through hole structure; and
the buckling assembly is protruded on a front end face or a rear end face of the isolation piece, the elastic arm is arranged on one side of one of the first connecting pieces away from another one of the first connecting pieces, and the hook portion is abutted against an edge of the limiting cavity away from the isolation piece.

9. The isolation structure for the electrical device as claimed in claim 1, wherein the front end face or rear end face of the isolation piece are recessed to form a plurality of breaking grooves, and a plurality of breaking grooves are arranged at intervals along a direction away from the buckling assembly.

10. The isolation structure as claimed in claim 1, wherein the clamping piece is provided with at least two terminal blocks, and at least two terminal blocks are arranged in different intervals.

11. The isolation structure for the electrical device as claimed in claim 8, wherein the clamping piece is provided with at least two terminal blocks, and at least two terminal blocks are arranged in different intervals.
